(19) United States
(12) Patent Application Publication
(10) Pub. No.: US 2012/0242887 A1
(43) Pub. Date: Sep. 27, 2012

(54) Zoom Lens System, Interchangeable Lens Apparatus and Camera System

(75) Inventors: Yoshio Matsumura, Osaka (JP); Takuya Imaoka, Kanagawa (JP)

(73) Assignee: PANASONIC CORPORATION, Osaka (JP)

(21) Appl. No.: 13/427,903

(22) Filed: Mar. 23, 2012

(30) Foreign Application Priority Data
Mar. 24, 2011 (JP) 2011-065572
Jan. 18, 2012 (JP) 2012-008496

(51) Int. Cl. H04N 5/232; G02B 15/14; G02B 27/64

(52) U.S. Cl. 348/345; 359/557; 348/E05.055

(57) ABSTRACT

A zoom lens system, in order from an object side to an image side, comprising a positive first lens unit, a negative second lens unit, a positive third lens unit, a negative fourth lens unit and a positive fifth lens unit, wherein the zoom lens system is provided with an image blur compensating lens unit moving in a direction perpendicular to an optical axis and being a part of the second lens unit or a part of the third lens unit, the first lens unit and the second lens unit individually move relative to an image surface in zooming, and the condition: T_{mainG}/T_{subG}>3.0 (T_{mainG}: an optical axial thickness of the lens unit containing the image blur compensating lens unit, T_{subG}: an optical axial thickness of the image blur compensating lens unit) is satisfied; an interchangeable lens apparatus; and a camera system are provided.

### CROSS-REFERENCE TO RELATED APPLICATION

This application is based on application No. 2011-065572 filed in Japan on Mar. 24, 2011 and application No. 2012-008496 filed in Japan on Jan. 18, 2012, the contents of which are hereby incorporated by reference.

### BACKGROUND OF THE INVENTION

1. Field of the Invention

The present invention relates to zoom lens systems, interchangeable lens apparatuses, and camera systems. In particular, the present invention relates to: compact and lightweight zoom lens systems having excellent optical performance as well as an excellent image blur compensation function and having a short overall length; and interchangeable lens apparatuses and camera systems each employing the zoom lens system.

2. Description of the Background Art

In recent years, interchangeable-lens type digital camera systems (also referred to simply as “camera systems”, hereinafter) have been spreading rapidly. Such interchangeable-lens type digital camera systems realize: taking of high-sensitive and high-quality images; high-speed focusing and high-speed image processing after image taking; and easy replacement of an interchangeable lens apparatus in accordance with a desired scene. Meanwhile, an interchangeable lens apparatus having a zoom lens system that forms an optical image with variable magnification is popular because it allows free change of focal length without the necessity of lens replacement.

Zoom lens systems having excellent optical performance from a wide-angle limit to a telephoto limit have been desired as zoom lens systems to be used in interchangeable lens apparatuses. Various kinds of zoom lens systems each having a positive lens unit located closest to an object side, and a multiple-unit construction have been proposed.

For example, Japanese Laid-Open Patent Publication No. 2005-352057 discloses a zoom lens having a construction that a positive lens unit is located closest to the object side, wherein a lens unit having negative optical power is arranged on the image side relative to a diaphragm, wherein the lens unit having negative optical power is constructed from two lens elements of negative optical power, and wherein one lens element serving as an image blur compensating lens unit moves in a direction perpendicular to an optical axis so that the imaging position is changed.

Japanese Laid-Open Patent Publication No. 2007-093977 discloses a zoom lens having a five-unit construction of positive, negative, positive, negative, and positive, wherein at the time of magnification change from a wide-angle limit to a telephoto limit, at least a first lens unit moves and changing manner of the intervals between the individual lens units is set forth, wherein a third lens unit, in order from the object side, comprises a first sub-lens unit having positive optical power, an aperture diaphragm, and a second sub-lens unit having positive optical power, and wherein the first sub-lens unit serving as an image blur compensating lens unit moves in a direction perpendicular to the optical axis so that the imaging position is changed.

Japanese Laid-Open Patent Publication No. 2007-219040 discloses a zoom lens having a construction of three lens units of positive, negative and positive, and at least one subsequent unit, wherein at the time of magnification change from a wide-angle limit to a telephoto limit, a first lens unit moves to the object side, a second lens unit is fixed, a third lens unit moves to the object side, and an image side part of the third lens serving as an image blur compensating lens unit moves in a direction perpendicular to the optical axis so that the imaging position is changed.

Japanese Laid-Open Patent Publication No. 2008-304706 discloses a zoom lens having a five-unit construction of positive, negative, positive, negative, and positive, and having a vibration-proof function, wherein a third lens unit includes lens elements having positive optical power and a cemented lens having positive optical power, wherein the cemented lens serving as an image blur compensating lens unit moves in a direction perpendicular to the optical axis so that the imaging position is changed, and wherein the average refractive index of positive lenses among the lens elements each having positive optical power is set forth.

However, although the zoom lenses disclosed in the above-mentioned patent documents have optical performance to a certain extent, the construction of the image blur compensating lens unit causes difficulty in reduction of the overall length of lens system. Thus, size reduction which is recently demanded is not achieved.

### SUMMARY OF THE INVENTION

An object of the present invention is to provide: a compact and lightweight zoom lens system having excellent optical performance as well as an excellent image blur compensation function and having a short overall length; and an interchangeable lens apparatus and a camera system each employing the zoom lens system.

The novel concepts disclosed herein were achieved in order to solve the foregoing problems in the conventional art, and herein is disclosed:

a zoom lens system having a plurality of lens units, each lens unit being composed of at least one lens element, the zoom lens system, in order from an object side to an image side, comprising:

a first lens unit having positive optical power;

a second lens unit having negative optical power;

a third lens unit having positive optical power;

a fourth lens unit having negative optical power; and

a fifth lens unit having positive optical power, wherein

the zoom lens system is provided with an image blur compensating lens unit which moves in a direction perpendicular to an optical axis in order to optically compensate image blur and which is a part of the second lens unit or a part of the third lens unit, wherein

in zooming from a wide-angle limit to a telephoto limit at the time of image taking, the first lens unit and the second lens unit individually move relative to an image surface, and wherein

the following condition (1) is satisfied:

T_{mainG}/T_{subG}>3.0 (1)

where,

T_{mainG} is an optical axial thickness of the lens unit containing the image blur compensating lens unit, and

T_{subG} is an optical axial thickness of the image blur compensating lens unit.

The novel concepts disclosed herein were achieved in order to solve the foregoing problems in the conventional art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power;

a third lens unit having positive optical power;

a fourth lens unit having negative optical power; and

a fifth lens unit having positive optical power, wherein

the zoom lens system is provided with an image blur compensating lens unit which moves in a direction perpendicular to an optical axis in order to optically compensate image blur and which is a part of the second lens unit or a part of the third lens unit, wherein

in zooming from a wide-angle limit to a telephoto limit at the time of image taking, the first lens unit and the second lens unit individually move relative to an image surface, and wherein

the following condition (1) is satisfied:

T_{mainG}/T_{subG}>3.0 (1)

where,

T_{mainG} is an optical axial thickness of the lens unit containing the image blur compensating lens unit, and

T_{subG} is an optical axial thickness of the image blur compensating lens unit.

The novel concepts disclosed herein were achieved in order to solve the foregoing problems in the conventional art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power;

a third lens unit having positive optical power;

a fourth lens unit having negative optical power; and

a fifth lens unit having positive optical power, wherein

the zoom lens system is provided with an image blur compensating lens unit which moves in a direction perpendicular to an optical axis in order to optically compensate image blur and which is a part of the second lens unit or a part of the third lens unit, wherein

in zooming from a wide-angle limit to a telephoto limit at the time of image taking, the first lens unit and the second lens unit individually move relative to an image surface, and wherein

the following condition (1) is satisfied:

T_{mainG}/T_{subG}>3.0 (1)

where,

T_{mainG} is an optical axial thickness of the lens unit containing the image blur compensating lens unit, and

T_{subG} is an optical axial thickness of the image blur compensating lens unit.

According to the present invention, it is possible to provide: a compact and lightweight zoom lens system having excellent optical performance as well as an excellent image blur compensation function and having a short overall length; and an interchangeable lens apparatus and a camera system each employing the zoom lens system.

### BRIEF DESCRIPTION OF THE DRAWINGS

This and other objects and features of this invention will become clear from the following description, taken in conjunction with the preferred embodiments with reference to the accompanied drawings in which:

FIG. 1 is a lens arrangement diagram showing an infinity in-focus condition of a zoom lens system according to Embodiment 1 (Example 1);

FIG. 2 is a longitudinal aberration diagram of an infinity in-focus condition of a zoom lens system according to Example 1;

FIG. 3 is a lateral aberration diagram of a zoom lens system according to Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Example 2);

FIG. 5 is a longitudinal aberration diagram of an infinity in-focus condition of a zoom lens system according to Example 2;

FIG. 6 is a lateral aberration diagram of a zoom lens system according to Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Example 3);

FIG. 8 is a longitudinal aberration diagram of an infinity in-focus condition of a zoom lens system according to Example 3;

FIG. 9 is a lateral aberration diagram of a zoom lens system according to Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Example 4);

FIG. 11 is a longitudinal aberration diagram of an infinity in-focus condition of a zoom lens system according to Example 4;

FIG. 12 is a lateral aberration diagram of a zoom lens system according to Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Example 5);

FIG. 14 is a longitudinal aberration diagram of an infinity in-focus condition of a zoom lens system according to Example 5;

FIG. 15 is a lateral aberration diagram of a zoom lens system according to Example 5 at a telephoto limit in a basic state where image blur compensation is not performed and in an image blur compensation state; and

FIG. 16 is a schematic construction diagram of an interchangeable-lens type digital camera system according to Embodiment 6.

### DESCRIPTION OF THE PREFERRED EMBODIMENTS

### Embodiments 1 to 5

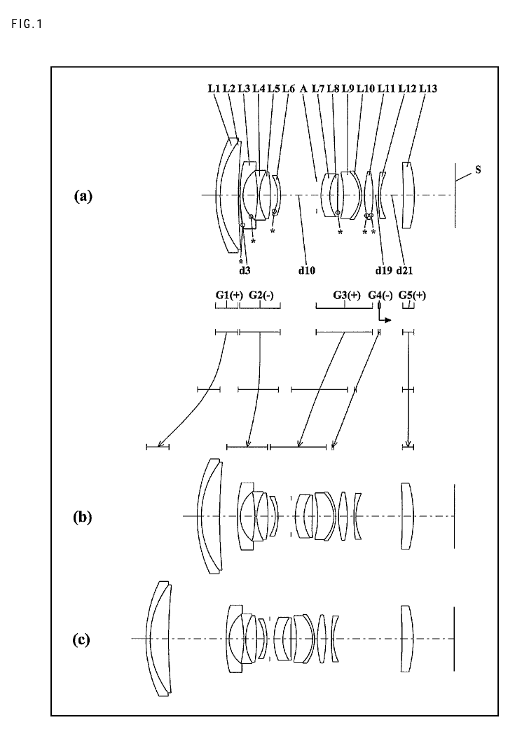

FIGS. 1, 4, 7, 10, and 13 are lens arrangement diagrams of zoom lens systems according to Embodiments 1 to 5, respectively.

Each of FIGS. 1, 4, 7, 10, and 13 shows a zoom lens system in an infinity in-focus condition. In each Fig., part (a) shows a lens configuration at a wide-angle limit (in the minimum focal length condition: focal length f_{w}), part (b) shows a lens configuration at a middle position (in an intermediate focal length condition: focal length f_{M}=√(f_{w}*f_{T})), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, the arrow indicates the moving direction at the time of focusing from an infinity in-focus condition to a close-object in-focus condition.

In FIGS. 1, 4, 7, 10, and 13, an asterisk “*” imparted to a particular surface indicates that the surface is aspheric. In each Fig., symbol (+) or (−) imparted to the symbol of each lens unit corresponds to the sign of the optical power of the lens unit. In each Fig., a straight line located on the most right-hand side indicates the position of an image surface S.

Further, as shown in FIGS. 1, 4, 7, 10, and 13, an aperture diaphragm A is provided between a second lens unit G2 and a third lens unit G3. In the zoom lens system according to each of Embodiments 1 to 5, in order that a satisfactory F-number at a telephoto limit is realized even in comparison with that at a wide-angle limit, the diameter of the aperture diaphragm in an open diaphragm state is maintained large in zooming from a wide-angle limit to a telephoto limit at the time of image taking.

As shown in FIG. 1, in the zoom lens system according to Embodiment 1, the first lens unit G1, in order from the object side to the image side, comprises: a negative meniscus first lens element L1 with the convex surface facing the object side; and a positive meniscus second lens element L2 with the convex surface facing the object side. The first lens element L1 and the second lens element L2 are cemented with each other.

In the zoom lens system according to Embodiment 1, the second lens unit G2, in order from the object side to the image side, comprises: a negative meniscus third lens element L3 with the convex surface facing the object side; a bi-concave fourth lens element L4; a bi-convex fifth lens element L5; and a negative meniscus sixth lens element L6 with the convex surface facing the image side. Among these, the fourth lens element L4 and the fifth lens element L5 are cemented with each other. The third lens element L3 has two aspheric surfaces, and the sixth lens element L6 has an aspheric object side surface.

In the zoom lens system according to Embodiment 1, the third lens unit G3, in order from the object side to the image side, comprises: a negative meniscus seventh lens element L7 with the convex surface facing the object side; a bi-convex eighth lens element L8; a positive meniscus ninth lens element L9 with the convex surface facing the image side; a negative meniscus tenth lens element L10 with the convex surface facing the image side; and a bi-convex eleventh lens element L11. Among these, the seventh lens element L7 and the eighth lens element L8 are cemented with each other, and the ninth lens element L9 and the tenth lens element L10 are cemented with each other. The eighth lens element L8 has an aspheric image side surface, and the eleventh lens element L11 has two aspheric surfaces.

In the zoom lens system according to Embodiment 1, the fourth lens unit G4 comprises solely a negative meniscus twelfth lens element L12 with the convex surface facing the object side.

In the zoom lens system according to Embodiment 1, the fifth lens unit G5 comprises solely a positive meniscus thirteenth lens element L13 with the convex surface facing the image side.

In the zoom lens system according to Embodiment 1, in zooming from a wide-angle limit to a telephoto limit at the time of image taking, the first lens unit G1 moves to the object side, the second lens unit G2 moves to the object side, the third lens unit G3 moves to the object side, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase. Further, the aperture diaphragm A moves together with the third lens unit G3 to the object side along the optical axis.

Further, in the zoom lens system according to Embodiment 1, in focusing from an infinity in-focus condition to a close-object in-focus condition, the fourth lens unit G4 moves to the image side along the optical axis.

Further, in the zoom lens system according to Embodiment 1, the eleventh lens element L11 corresponds to an image blur compensating lens unit described later. Then, by moving the eleventh lens element L11 in a direction perpendicular to the optical axis, image point movement caused by vibration of the entire system can be compensated, that is, image blur caused by hand blur, vibration, and the like can be compensated optically.

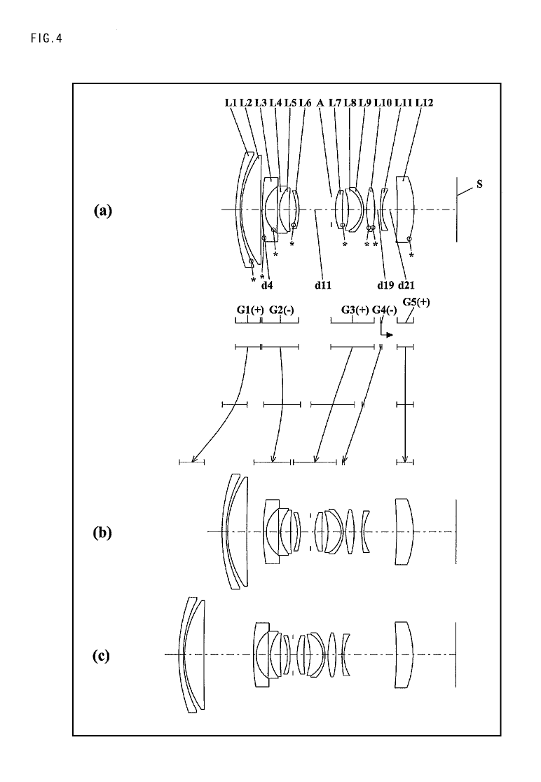

As shown in FIG. 4, in the zoom lens system according to Embodiment 2, the first lens unit G1, in order from the object side to the image side, comprises: a negative meniscus first lens element L1 with the convex surface facing the object side; and a positive meniscus second lens element L2 with the convex surface facing the object side. The first lens element L1 has an aspheric image side surface.

In the zoom lens system according to Embodiment 2, the second lens unit G2, in order from the object side to the image side, comprises: a negative meniscus third lens element L3 with the convex surface facing the object side; a bi-concave fourth lens element L4; a positive meniscus fifth lens element L5 with the convex surface facing the object side; and a negative meniscus sixth lens element L6 with the convex surface facing the image side. Among these, the fourth lens element L4 and the fifth lens element L5 are cemented with each other. The third lens element L3 has two aspheric surfaces, and the sixth lens element L6 has an aspheric object side surface.

In the zoom lens system according to Embodiment 2, the third lens unit G3, in order from the object side to the image side, comprises: a positive meniscus seventh lens element L7 with the convex surface facing the object side; a positive meniscus eighth lens element L8 with the convex surface facing the image side; a negative meniscus ninth lens element L9 with the convex surface facing the image side; and a bi-convex tenth lens element L10. Among these, the eighth lens element L8 and the ninth lens element L9 are cemented with each other. The seventh lens element L7 has an aspheric image side surface, and the tenth lens element L10 has two aspheric surfaces.

In the zoom lens system according to Embodiment 2, the fourth lens unit G4 comprises solely a negative meniscus eleventh lens element L11 with the convex surface facing the object side.

In the zoom lens system according to Embodiment 2, the fifth lens unit G5 comprises solely a positive meniscus twelfth lens element L12 with the convex surface facing the image side. The twelfth lens element L12 has an aspheric image side surface.

In the zoom lens system according to Embodiment 2, in zooming from a wide-angle limit to a telephoto limit at the time of image taking, the first lens unit G1 moves to the object side, the second lens unit G2 moves to the object side with locus of a convex to the image side, the third lens unit G3 moves to the object side, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase. Further, the aperture diaphragm A moves together with the third lens unit G3 to the object side along the optical axis.

Further, in the zoom lens system according to Embodiment 2, in focusing from an infinity in-focus condition to a close-object in-focus condition, the fourth lens unit G4 moves to the image side along the optical axis.

Further, in the zoom lens system according to Embodiment 2, the tenth lens element L10 corresponds to an image blur compensating lens unit described later. Then, by moving the tenth lens element L10 in a direction perpendicular to the optical axis, image point movement caused by vibration of the entire system can be compensated, that is, image blur caused by hand blur, vibration, and the like can be compensated optically.

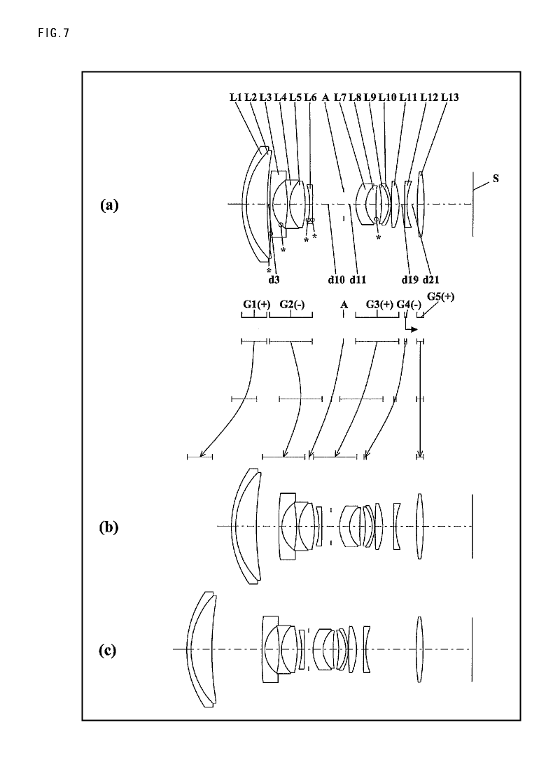

As shown in FIG. 7, in the zoom lens system according to Embodiment 3, the first lens unit G1, in order from the object side to the image side, comprises: a negative meniscus first lens element L1 with the convex surface facing the object side; and a positive meniscus second lens element L2 with the convex surface facing the object side. The first lens element L1 and the second lens element L2 are cemented with each other.

In the zoom lens system according to Embodiment 3, the second lens unit G2, in order from the object side to the image side, comprises: a negative meniscus third lens element L3 with the convex surface facing the object side; a bi-concave fourth lens element L4; a bi-convex fifth lens element L5; and a bi-concave sixth lens element L6. Among these, the fourth lens element L4 and the fifth lens element L5 are cemented with each other. The third lens element L3 has two aspheric surfaces, and the sixth lens element L6 also has two aspheric surfaces.

In the zoom lens system according to Embodiment 3, the third lens unit G3, in order from the object side to the image side, comprises: a negative meniscus seventh lens element L7 with the convex surface facing the object side; a positive meniscus eighth lens element L8 with the convex surface facing the object side; a positive meniscus ninth lens element L9 with the convex surface facing the image side; a negative meniscus tenth lens element L10 with the convex surface facing the image side; and a bi-convex eleventh lens element L11. Among these, the seventh lens element L7 and the eighth lens element L8 are cemented with each other, and the ninth lens element L9 and the tenth lens element L10 are cemented with each other. The eighth lens element L8 has an aspheric image side surface.

In the zoom lens system according to Embodiment 3, the fourth lens unit G4 comprises solely a negative meniscus twelfth lens element L12 with the convex surface facing the object side.

In the zoom lens system according to Embodiment 3, the fifth lens unit G5 comprises solely a bi-convex thirteenth lens element L13.

In the zoom lens system according to Embodiment 3, in zooming from a wide-angle limit to a telephoto limit at the time of image taking, the first lens unit G1 moves to the object side, the second lens unit G2 moves to the object side with locus of a convex to the image side, the third lens unit G3 moves to the object side, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase. Further, the aperture diaphragm A independently moves to the object side along the optical axis.

Further, in the zoom lens system according to Embodiment 3, in focusing from an infinity in-focus condition to a close-object in-focus condition, the fourth lens unit G4 moves to the image side along the optical axis.

Further, in the zoom lens system according to Embodiment 3, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

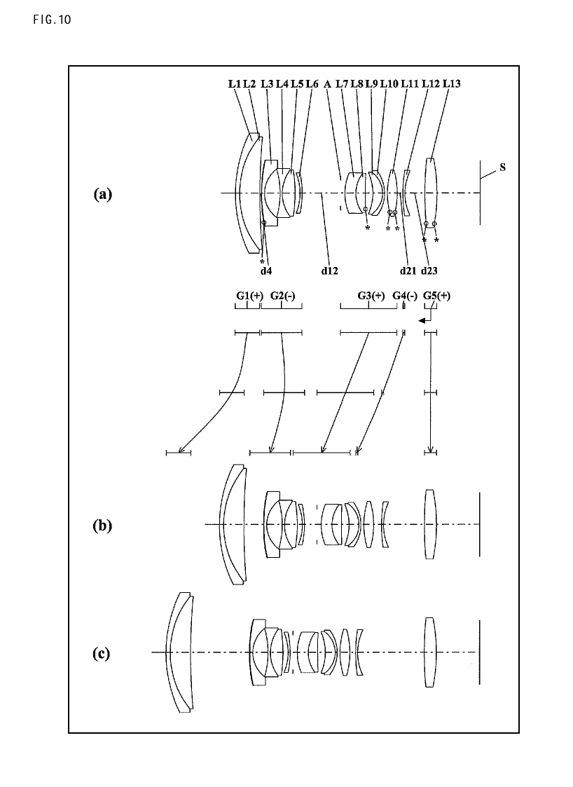

As shown in FIG. 10, in the zoom lens system according to Embodiment 4, the first lens unit G1, in order from the object side to the image side, comprises: a negative meniscus first lens element L1 with the convex surface facing the object side; and a positive meniscus second lens element L2 with the convex surface facing the object side. The first lens element L1 and the second lens element L2 are cemented with each other. In the surface data of the corresponding Numerical Example described later, surface number 2 is imparted to an adhesive layer between the first lens element L1 and the second lens element L2.

In the zoom lens system according to Embodiment 4, the second lens unit G2, in order from the object side to the image side, comprises: a negative meniscus third lens element L3 with the convex surface facing the object side; a bi-concave fourth lens element L4; a bi-convex fifth lens element L5; and a negative meniscus sixth lens element L6 with the convex surface facing the image side. Among these, the fourth lens element L4 and the fifth lens element L5 are cemented with each other. Further, a transparent resin layer is cemented to an object side surface of the third lens element L3. Then, an object side surface of the transparent resin layer is aspheric.

In the zoom lens system according to Embodiment 4, the third lens unit G3, in order from the object side to the image side, comprises: a negative meniscus seventh lens element L7 with the convex surface facing the object side; a bi-convex eighth lens element L8; a positive meniscus ninth lens element L9 with the convex surface facing the image side; a negative meniscus tenth lens element L10 with the convex surface facing the image side; and a bi-convex eleventh lens element L11. Among these, the seventh lens element L7 and the eighth lens element L8 are cemented with each other, and the ninth lens element L9 and the tenth lens element L10 are cemented with each other. The eighth lens element L8 has an aspheric image side surface, and the eleventh lens element L11 has two aspheric surfaces.

In the zoom lens system according to Embodiment 4, the fourth lens unit G4 comprises solely a negative meniscus twelfth lens element L12 with the convex surface facing the object side.

In the zoom lens system according to Embodiment 4, the fifth lens unit G5 comprises solely a bi-convex thirteenth lens element L13. The thirteenth lens element L13 has two aspheric surfaces.

In the zoom lens system according to Embodiment 4, in zooming from a wide-angle limit to a telephoto limit at the time of image taking, the first lens unit G1 moves to the object side, the second lens unit G2 moves to the object side with locus of a convex to the image side, the third lens unit G3 moves to the object side, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase. Further, the aperture diaphragm A moves together with the third lens unit G3 to the object side along the optical axis.

Further, in the zoom lens system according to Embodiment 4, in focusing from an infinity in-focus condition to a close-object in-focus condition, the fifth lens unit G5 moves to the object side along the optical axis.

Further, in the zoom lens system according to Embodiment 4, the eleventh lens element L11 corresponds to an image blur compensating lens unit described later. Then, by moving the eleventh lens element L11 in a direction perpendicular to the optical axis, image point movement caused by vibration of the entire system can be compensated, that is, image blur caused by hand blur, vibration, and the like can be compensated optically.

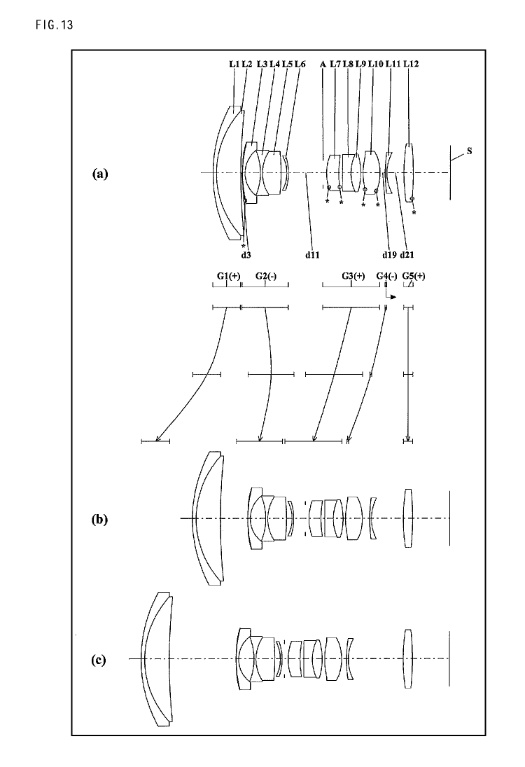

As shown in FIG. 13, in the zoom lens system according to Embodiment 5, the first lens unit G1, in order from the object side to the image side, comprises: a negative meniscus first lens element L1 with the convex surface facing the object side; and a positive meniscus second lens element L2 with the convex surface facing the object side. The first lens element L1 and the second lens element L2 are cemented with each other.

In the zoom lens system according to Embodiment 5, the second lens unit G2, in order from the object side to the image side, comprises: a negative meniscus third lens element L3 with the convex surface facing the object side; a bi-concave fourth lens element L4; a bi-convex fifth lens element L5; and a negative meniscus sixth lens element L6 with the convex surface facing the image side. Among these, the fourth lens element L4 and the fifth lens element L5 are cemented with each other. Further, a transparent resin layer is cemented to an object side surface of the third lens element L3. Then, an object side surface of the transparent resin layer is aspheric.

In the zoom lens system according to Embodiment 5, the third lens unit G3, in order from the object side to the image side, comprises: a positive meniscus seventh lens element L7 with the convex surface facing the object side; a bi-concave eighth lens element L8; a bi-convex ninth lens element L9; and a bi-convex tenth lens element L10. Among these, the eighth lens element L8 and the ninth lens element L9 are cemented with each other. The seventh lens element L7 has two aspheric surfaces, and the tenth lens element L10 also has two aspheric surfaces.

In the zoom lens system according to Embodiment 5, the fourth lens unit G4 comprises solely a negative meniscus eleventh lens element L11 with the convex surface facing the object side.

In the zoom lens system according to Embodiment 5, the fifth lens unit G5 comprises solely a bi-convex twelfth lens element L12. The twelfth lens element L12 has an aspheric image side surface.

In the zoom lens system according to Embodiment 5, in zooming from a wide-angle limit to a telephoto limit at the time of image taking, the first lens unit G1 moves to the object side, the second lens unit G2 moves to the object side with locus of a convex to the image side, the third lens unit G3 moves to the object side, the fourth lens unit G4 moves to the object side, and the fifth lens unit G5 does not move. That is, in zooming, the first lens unit G1, the second lens unit G2, the third lens unit G3, and the fourth lens unit G4 individually move along the optical axis such that the interval between the first lens unit G1 and the second lens unit G2 should increase, that the interval between the second lens unit G2 and the third lens unit G3 should decrease, and that the interval between the fourth lens unit G4 and the fifth lens unit G5 should increase. Further, the aperture diaphragm A moves together with the third lens unit G3 to the object side along the optical axis.

Further, in the zoom lens system according to Embodiment 5, in focusing from an infinity in-focus condition to a close-object in-focus condition, the fourth lens unit G4 moves to the image side along the optical axis.

Further, in the zoom lens system according to Embodiment 5, the tenth lens element L10 corresponds to an image blur compensating lens unit described later. Then, by moving the tenth lens element L10 in a direction perpendicular to the optical axis, image point movement caused by vibration of the entire system can be compensated, that is, image blur caused by hand blur, vibration, and the like can be compensated optically.

The following description is given for conditions preferred to be satisfied by a zoom lens system like the zoom lens systems according to Embodiments 1 to 5. Here, a plurality of preferable conditions are set forth for the zoom lens system according to each embodiment. A construction that satisfies all the plural conditions is most desirable for the zoom lens system. However, when an individual condition is satisfied, a zoom lens system having the corresponding effect can be obtained.

For example, in a zoom lens system like the zoom lens systems according to Embodiments 1 to 5, having a plurality of lens units, each lens unit being composed of at least one lens element, the zoom lens system, in order from an object side to an image side, comprising: a first lens unit having positive optical power; a second lens unit having negative optical power; a third lens unit having positive optical power; a fourth lens unit having negative optical power; and a fifth lens unit having positive optical power, wherein the zoom lens system is provided with an image blur compensating lens unit which moves in a direction perpendicular to the optical axis in order to optically compensate image blur and which is a part of the second lens unit or a part of the third lens unit, and wherein in zooming from a wide-angle limit to a telephoto limit at the time of image taking, the first lens unit and the second lens unit individually move relative to the image surface (this lens configuration is referred to as a basic configuration of the embodiment, hereinafter), the following condition (1) is satisfied.

T_{mainG}/T_{subG}>3.0 (1)

where,

T_{mainG} is an optical axial thickness of the lens unit containing the image blur compensating lens unit, and

T_{subG} is an optical axial thickness of the image blur compensating lens unit.

The condition (1) sets forth a relationship between the optical axial thickness of the lens unit containing the image blur compensating lens unit and the optical axial thickness of the image blur compensating lens unit. When the condition (1) is not satisfied, the optical axial thickness of the image blur compensating lens unit becomes excessively large, and therefore compensation of decentering astigmatism at the time of image blur compensation becomes difficult.

When the following condition (1)′ is satisfied, the above-mentioned effect is achieved more successfully.

T_{mainG}/T_{subG}>5.0 (1)'

In a zoom lens system having the basic configuration like the zoom lens systems according to Embodiments 1 to 5, it is preferable that the following condition (2) is satisfied.

1.3<f_{1G}/|f_{subG}|<8.5 (2)

where,

f_{1G} is a focal length of the first lens unit, and

f_{subG} is a focal length of the image blur compensating lens unit.

The condition (2) sets forth a relationship between the focal length of the first lens unit and the focal length of the image blur compensating lens unit. When the value goes below the lower limit of the condition (2), the focal length of the first lens unit becomes excessively short, and therefore control of astigmatism at a telephoto limit becomes difficult. In contrast, when the value exceeds the upper limit of the condition (2), the focal length of the image blur compensating lens unit becomes excessively short, and therefore compensation of decentering astigmatism at the time of image blur compensation becomes difficult.

When at least one of the following conditions (2)′ and (2)″ is satisfied, the above-mentioned effect is achieved more successfully.

1.50<f_{1G}/|f_{subG}| (2)′

f_{1G}/|f_{subG}|<2.51 (2)″

In a zoom lens system having the basic configuration like the zoom lens systems according to Embodiments 1 to 5, it is preferable that the following condition (3) is satisfied.

1.5<L_{T}/|f_{subG}|<9.0 (3)

where,

L_{T} is an overall length of lens system at a telephoto limit (a distance from an object side surface of a lens element arranged closest to the object side in the first lens unit, to the image surface at a telephoto limit), and

f_{subG} is a focal length of the image blur compensating lens unit.

The condition (3) sets forth a relationship between the overall length of lens system at a telephoto limit and the focal length of the image blur compensating lens unit. When the value goes below the lower limit of the condition (3), the overall length of lens system at a telephoto limit becomes excessively short, and therefore the focal length of each lens unit becomes excessively short. Thus, control of fluctuation of spherical aberration in association with zooming becomes difficult. In contrast, when the value exceeds the upper limit of the condition (3), the focal length of the image blur compensating lens unit becomes excessively short, and therefore compensation of decentering astigmatism at the time of image blur compensation at a telephoto limit becomes difficult.

When at least one of the following conditions (3)′ and (3)″ is satisfied, the above-mentioned effect is achieved more successfully.

2.0<L_{T}/|f_{subG}| (3)′

L_{T}/|f_{subG}|<4.3 (3)″

Each of the zoom lens systems according to Embodiments 1 to 5 is provided with an image blur compensating lens unit which moves in a direction perpendicular to the optical axis in order to optically compensate image blur and which is a part of the second lens unit or a part of the third lens unit. By virtue of this image blur compensating lens unit, image point movement caused by vibration of the entire system can be compensated.

When compensating image point movement caused by vibration of the entire system, the image blur compensating lens unit moves in the direction perpendicular to the optical axis, so that image blur is compensated in a state that size increase in the entire zoom lens system is suppressed to realize a compact construction and that excellent imaging characteristics such as small decentering coma aberration and small decentering astigmatism are satisfied.

It is preferable that the image blur compensating lens unit is arranged closest to the image side in the lens unit containing the image blur compensating lens unit. When the image blur compensating lens unit is arranged not closest to the most image side, the configuration of the drive mechanism for the image blur compensating lens unit becomes complicated, and therefore it becomes difficult to provide compact lens barrel, interchangeable lens apparatus, and camera system. Further, compensation of unilateral blur in the sagittal image surface at the time of image blur compensation becomes difficult.

The image blur compensating lens unit may be composed of any one lens element or a plurality of adjacent lens elements among all the lens elements constituting the second lens unit or the third lens unit. However, it is preferable that the image blur compensating lens unit is composed of one lens element. When the image blur compensating lens unit is composed of a plurality of lens elements, the configuration of the drive mechanism for the image blur compensating lens unit becomes enlarged, and therefore it becomes difficult to provide compact lens barrel, interchangeable lens apparatus, and camera system.

Like in the zoom lens systems according to Embodiments 1 to 5, it is preferable that the first lens unit is composed of two or less lens elements. When the first lens unit is composed of three or more lens elements, the diameter of the first lens unit becomes large, and therefore compensation of astigmatism at a wide-angle limit becomes difficult.

Like in the zoom lens systems according to Embodiments 1 to 5, it is preferable that the fifth lens unit is composed of one lens element. When the fifth lens unit is composed of a plurality of lens elements, compensation of curvature of field at a telephoto limit becomes difficult.

Further, like in the zoom lens systems according to Embodiments 1 to 5, it is preferable that the fifth lens unit is fixed relative to the image surface in zooming from a wide-angle limit to a telephoto limit at the time of image taking. When the fifth lens unit moves relative to the image surface in zooming, the frame for holding the fifth lens unit becomes excessively large. Thus, it becomes difficult to provide compact lens barrel, interchangeable lens apparatus, and camera system. Further, the focal length of the fifth lens unit becomes excessively long, and therefore compensation of curvature of field at a telephoto limit becomes difficult.

Like in the zoom lens systems according to Embodiments 1 to 5, it is preferable that a zoom lens system is provided with a focusing lens unit which moves relative to the image surface in focusing from an infinity in-focus condition to a close-object in-focus condition, and that the focusing lens unit is composed of one lens element. When the focusing lens unit is composed of a plurality of lens elements, rapid focusing becomes difficult.

Further, like in the zoom lens systems according to Embodiments 2, 3, and 5, it is preferable that an air lens located closest to the object side in the third lens unit is bi-convex. When the air lens located closest to the object side in the third lens unit is bi-convex, compensation of spherical aberration at a wide-angle limit is achieved more satisfactory.

Each of the lens units constituting the zoom lens system according to any of Embodiments 1 to 5 is composed exclusively of refractive type lens elements that deflect the incident light by refraction (that is, lens elements of a type in which deflection is achieved at the interface between media each having a distinct refractive index). However, the present invention is not limited to this. For example, the lens units may employ diffractive type lens elements that deflect the incident light by diffraction; refractive-diffractive hybrid type lens elements that deflect the incident light by a combination of diffraction and refraction; or gradient index type lens elements that deflect the incident light by distribution of refractive index in the medium. In particular, in refractive-diffractive hybrid type lens elements, when a diffraction structure is formed in the interface between media having mutually different refractive indices, wavelength dependence in the diffraction efficiency is improved. Thus, such a configuration is preferable.

### Embodiment 6

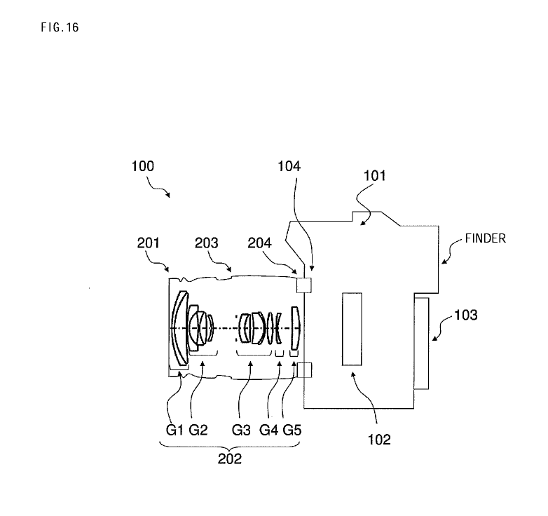

FIG. 16 is a schematic construction diagram of an interchangeable-lens type digital camera system according to Embodiment 6.

The interchangeable-lens type digital camera system 100 according to Embodiment 6 includes a camera body 101, and an interchangeable lens apparatus 201 which is detachably connected to the camera body 101.

The camera body 101 includes: an image sensor 102 which receives an optical image formed by a zoom lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a zoom lens system 202 according to any of Embodiments 1 to 5; a lens barrel 203 which holds the zoom lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 16, the zoom lens system according to Embodiment 1 is employed as the zoom lens system 202.

In Embodiment 6, since the zoom lens system 202 according to any of Embodiments 1 to 5 is employed, a compact interchangeable lens apparatus having excellent imaging performance can be realized at low cost. Moreover, size reduction and cost reduction of the entire camera system 100 according to Embodiment 6 can be achieved. In the zoom lens systems according to Embodiments 1 to 5, the entire zooming range need not be used. That is, in accordance with a desired zooming range, a range where satisfactory optical performance is obtained may exclusively be used. Then, the zoom lens system may be used as one having a lower magnification than the zoom lens systems described in Embodiments 1 to 5.

The following description is given for numerical examples in which the zoom lens system according to Embodiments 1 to 5 are implemented practically. In the numerical examples, the units of the length in the tables are all “mm”, while the units of the view angle are all “°”. Moreover, in the numerical examples, r is the radius of curvature, d is the axial distance, nd is the refractive index to the d-line, and vd is the Abbe number to the d-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

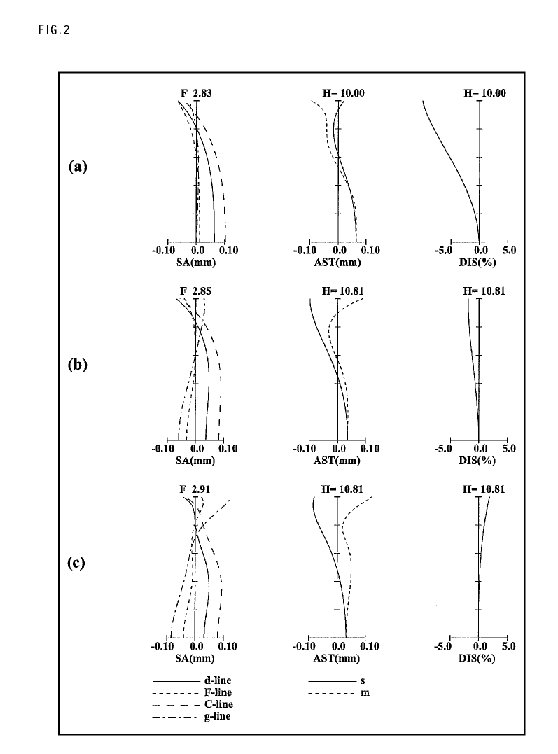

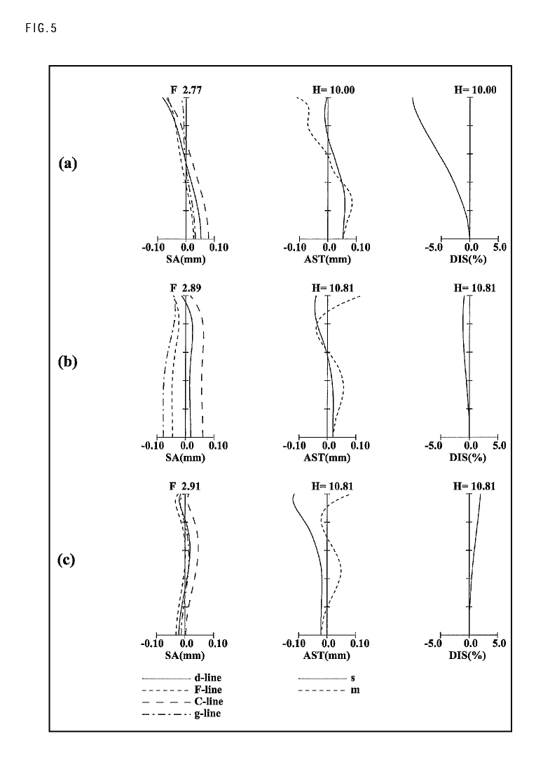

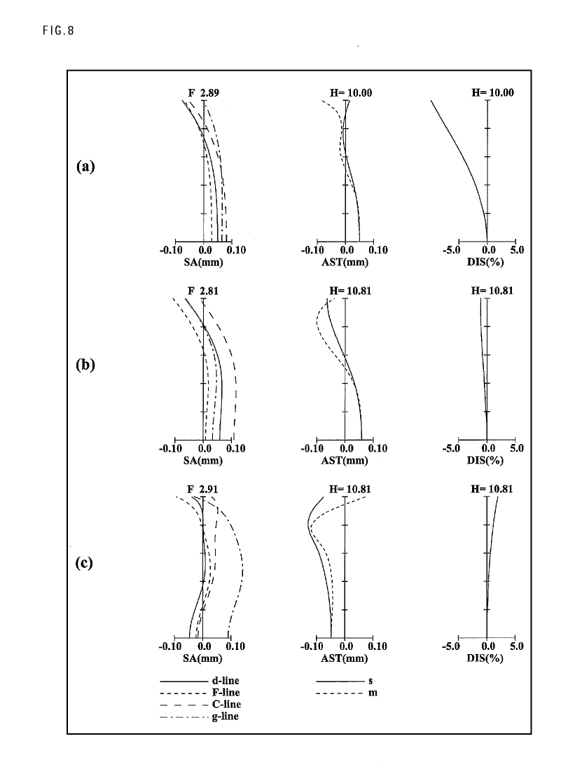

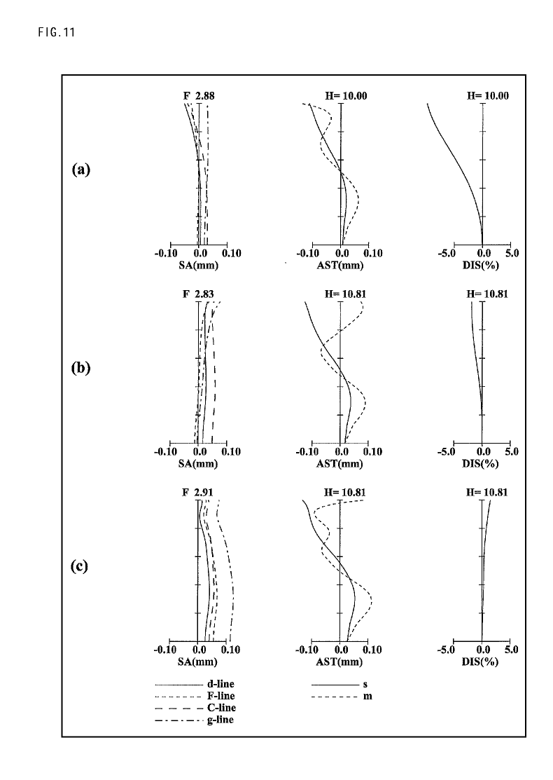

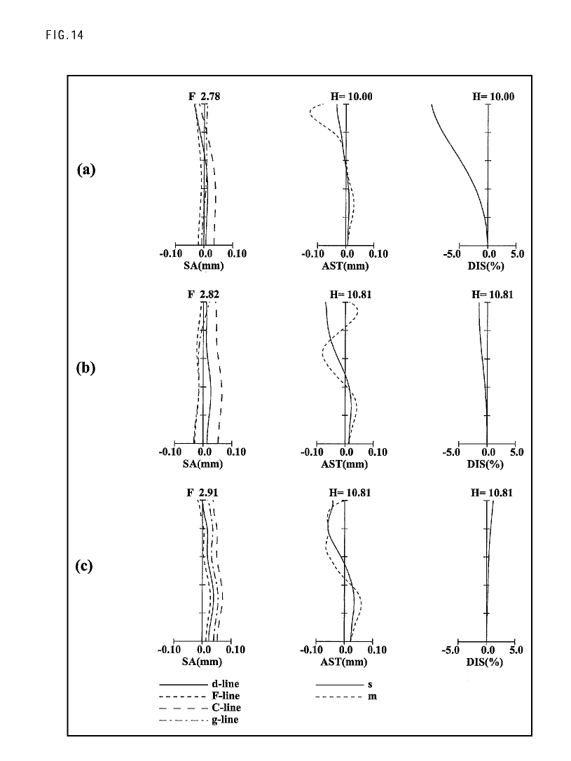

FIGS. 2, 5, 8, 11 and 14 are longitudinal aberration diagrams of an infinity in-focus condition of the zoom lens systems according to Numerical Examples 1 to 5, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line, the long dash line and the one-dot dash line indicate the characteristics to the d-line, the F-line, the C-line and the g-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

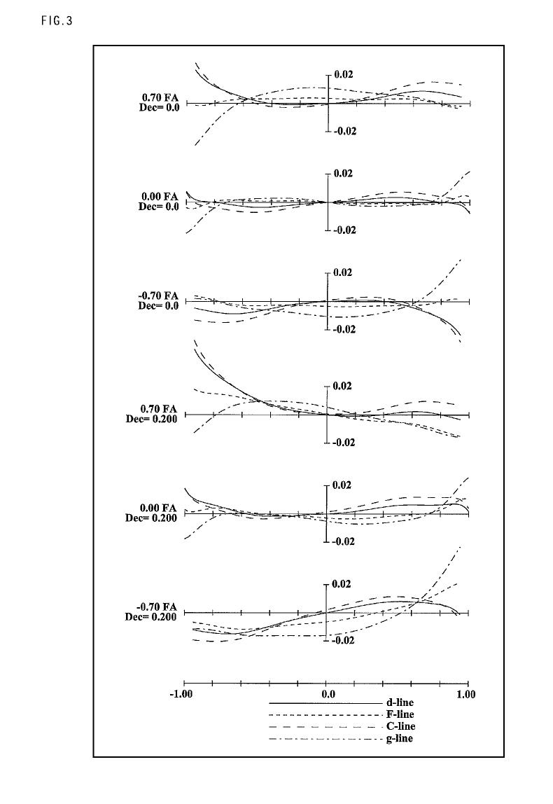

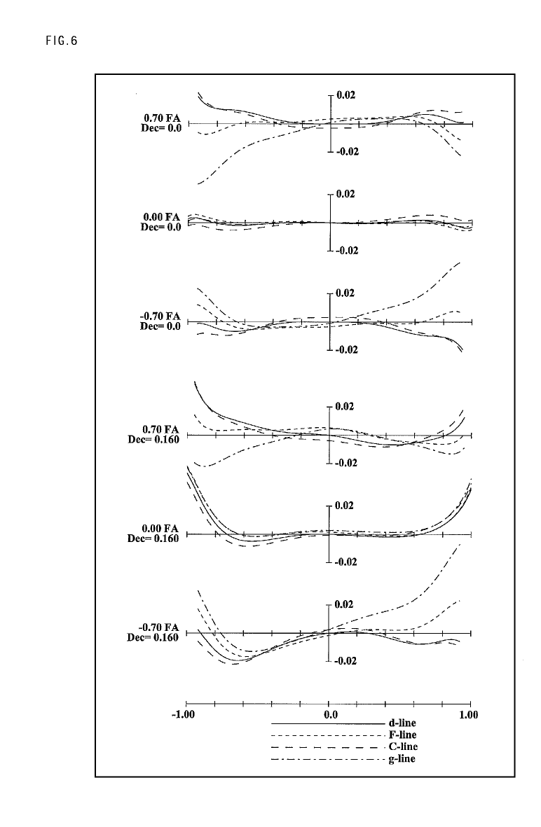

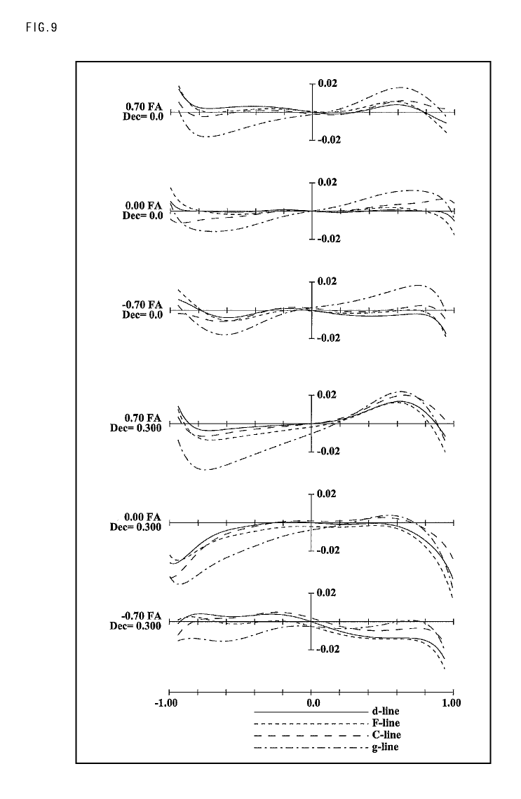

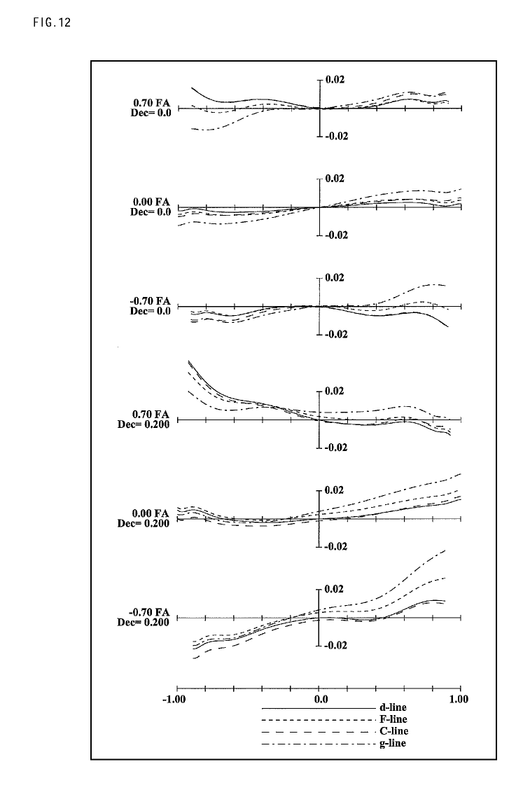

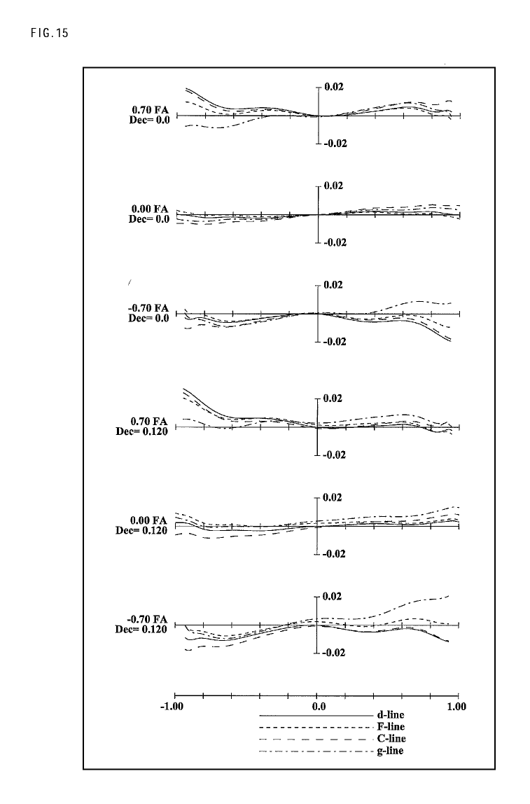

FIGS. 3, 6, 9, 12 and 15 are lateral aberration diagrams of the zoom lens systems at a telephoto limit according to Numerical Examples 1 to 5, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line, the long dash line and the one-dot dash line indicate the characteristics to the d-line, the F-line, the C-line and the g-line, respectively. In each lateral aberration diagram, the meridional plane is adopted as the plane containing the optical axis of the first lens unit G1 and the optical axis of the second lens unit G2 (Numerical Example 3) or the plane containing the optical axis of the first lens unit G1 and the optical axis of the third lens unit G3 (Numerical Examples 1, 2, 4 and 5).

Here, in the zoom lens system according to each numerical example, the amount of movement of the image blur compensating lens unit in a direction perpendicular to the optical axis in an image blur compensation state at a telephoto limit is as follows.

### Numerical Example 1 0.200 mm

### Numerical Example 2 0.160 mm

### Numerical Example 3 0.300 mm

### Numerical Example 4 0.200 mm

### Numerical Example 5 0.120 mm

Here, when the shooting distance is infinity, at a telephoto limit, the amount of image decentering in a case that the zoom lens system inclines by 0.4° is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.4° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd |
|---|---|---|---|---|
| Object surface | ∞ | | | |
| 1 | 46.56480 | 1.50000 | 1.84666 | 23.8 |
| 2 | 31.80790 | 6.46400 | 1.77250 | 49.6 |
| 3 | 194.87370 | Variable | | |
| 4* | 133.72500 | 1.00000 | 1.88202 | 37.2 |
| 5* | 11.99180 | 5.11050 | | |
| 6 | −40.62420 | 0.70000 | 1.70154 | 41.1 |
| 7 | 16.72220 | 3.88980 | 1.92286 | 20.9 |
| 8 | −52.04510 | 2.59450 | | |
| 9* | −12.84400 | 1.00000 | 1.80610 | 40.7 |
| 10 | −19.95800 | Variable | | |
| 11(Diaphragm) | ∞ | 1.50000 | | |
| 12 | 19.13050 | 3.08930 | 1.84666 | 23.8 |
| 13 | 14.31570 | 2.84000 | 1.58913 | 61.3 |
| 14* | −277.48550 | 1.99460 | | |
| 15 | −33.06230 | 5.68070 | 1.59282 | 68.6 |
| 16 | −11.77870 | 0.70000 | 1.92286 | 20.9 |
| 17 | −14.70730 | 1.00000 | | |
| 18* | 28.58940 | 2.96360 | 1.51845 | 70.0 |
| 19* | −44.72510 | Variable | | |
| 20 | 65.42230 | 0.70000 | 1.74950 | 35.0 |
| 21 | 18.62770 | Variable | | |
| 22 | −226.93210 | 3.95860 | 1.84666 | 23.8 |
| 23 | −45.58570 | (BF) | | |
| Image surface | ∞ | | | |

TABLE 2
(Aspherical data)

Surface No. 4
K = 0.00000E+00, A4 = 6.64668E−05, A6 = −2.84118E−07,
A8 = 6.25525E−10 A10 = 0.00000E+00
Surface No. 5
K = 0.00000E+00, A4 = 5.54426E−05, A6 = 1.90885E−07,
A8 = 2.57948E−09 A10 = −4.89308E−12
Surface No. 9
K = 0.00000E+00, A4 = 2.01586E−05, A6 = 3.61764E−07,
A8 = −3.69683E−09 A10 = 1.91593E−11
Surface No. 14
K = 0.00000E+00, A4 = 9.23458E−05, A6 = 1.59711E−07,
A8 = 9.09639E−10 A10 = −1.77556E−11
Surface No. 18
K = 0.00000E+00, A4 = −2.85196E−05, A6 = −2.27314E−08,
A8 = 1.43135E−10 A10 = −1.08350E−12
Surface No. 19
K = 0.00000E+00, A4 = −1.05035E−05, A6 = −1.75961E−08,
A8 = −1.49536E−10 A10 = 0.00000E+00

TABLE 3
(Various data)
Zooming ratio 2.75039

| | Wide-angle | Middle | Telephoto |
|---|---|---|---|
| | limit | position | limit |
| Focal length | 12.3628 | 20.5037 | 34.0025 |
| F-number | 2.82859 | 2.85057 | 2.91257 |
| View angle | 41.9636 | 28.2703 | 17.3406 |
| Image height | 10.0000 | 10.8150 | 10.8150 |
| Overall length | 84.4390 | 90.7009 | 108.5390 |
| of lens system | | | |
| d3 | 0.6000 | 6.3474 | 20.3334 |
| d10 | 12.7430 | 4.5346 | 1.0000 |
| d19 | 2.0000 | 2.4285 | 2.0000 |
| d21 | 8.0000 | 16.2944 | 24.1096 |
| Entrance pupil | 18.4284 | 25.5267 | 54.8371 |
| position | | | |
| Exit pupil | −66.5649 | −101.2176 | −157.4588 |
| position | | | |
| Front principal | 28.4973 | 41.8785 | 81.4984 |
| points position | | | |
| Back principal | 72.1413 | 70.2338 | 74.5687 |
| points position | | | |

Zoom lens unit data

| | Initial | | Overall | Front principal | Back principal |
|---|---|---|---|---|---|
| Lens | surface | Focal | length of | points | points |
| unit | No. | length | lens unit | position | position |
| 1 | 1 | 81.90412 | 7.96400 | −1.60513 | 2.00956 |
| 2 | 4 | −12.82855 | 14.29480 | 1.44731 | 5.10202 |
| 3 | 11 | 16.16475 | 19.76820 | 10.80729 | 13.61390 |
| 4 | 20 | −34.97114 | 0.70000 | 0.56300 | 0.86030 |
| 5 | 22 | 66.70830 | 3.95860 | 2.65593 | 4.49212 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd |
|---|---|---|---|---|
| Object surface | ∞ | | | |
| 1 | 61.17090 | 1.50000 | 2.10205 | 16.8 |
| 2* | 43.75380 | 0.50000 | | |
| 3 | 34.17190 | 6.76700 | 1.81550 | 44.4 |
| 4 | 777.73550 | Variable | | |
| 5* | 141.32940 | 1.00000 | 1.88202 | 37.2 |
| 6* | 10.68920 | 4.31210 | | |
| 7 | −228.29100 | 0.70000 | 1.60368 | 50.3 |
| 8 | 12.21750 | 3.49100 | 1.92286 | 20.9 |
| 9 | 91.38360 | 2.50000 | | |
| 10* | −16.62500 | 1.00000 | 1.80139 | 45.4 |
| 11 | −24.86500 | Variable | | |
| 12(Diaphragm) | ∞ | 1.50000 | | |
| 13 | 19.28640 | 2.39090 | 1.61881 | 63.9 |
| 14* | 299.33480 | 2.18510 | | |
| 15 | −22.43550 | 4.54530 | 1.59282 | 68.6 |
| 16 | −8.37970 | 0.70000 | 1.90366 | 31.3 |
| 17 | −11.66580 | 1.00000 | | |
| 18* | 23.32070 | 2.85180 | 1.58913 | 61.3 |
| 19* | −39.24490 | Variable | | |
| 20 | 47.80150 | 0.70000 | 1.84666 | 23.8 |
| 21 | 14.09310 | Variable | | |
| 22 | −142.52320 | 5.83060 | 1.82115 | 24.1 |
| 23* | −33.63690 | (BF) | | |
| Image surface | ∞ | | | |

TABLE 5
(Aspherical data)

Surface No. 2
K = 0.00000E+00, A4 = 5.52161E−07, A6 = 7.17077E−10,
A8 = 7.29088E−13 A10 = 0.00000E+00
Surface No. 5
K = 0.00000E+00, A4 = 6.17222E−05, A6 = −4.01792E−07,
A8 = 7.82240E−10 A10 = 0.00000E+00
Surface No. 6
K = 0.00000E+00, A4 = 7.09700E−05, A6 = −3.19609E−07,
A8 = 1.92166E−08 A10 = −1.97353E−10
Surface No. 10
K = 0.00000E+00, A4 = 1.16544E−05, A6 = 9.35916E−07,
A8 = −1.96846E−08 A10 = 1.51878E−10
Surface No. 14
K = 0.00000E+00, A4 = 9.04204E−05, A6 = 7.41893E−07,
A8 = −5.78817E−09 A10 = −1.00886E−11
Surface No. 18
K = 0.00000E+00, A4 = −7.19325E−05, A6 = −1.77148E−07,
A8 = 3.52431E−09 A10 = −1.29793E−11
Surface No. 19
K = 0.00000E+00, A4 = −4.30272E−05, A6 = −5.39419E−08,
A8 = 1.16011E−09 A10 = 0.00000E+00
Surface No. 23
K = 0.00000E+00, A4 = −2.07789E−08, A6 = −3.34311E−08,
A8 = −4.42426E−12 A10 = 0.00000E+00

TABLE 6
(Various data)
Zooming ratio 2.75001

| | Wide-angle | Middle | Telephoto |
|---|---|---|---|
| | limit | position | limit |
| Focal length | 12.3627 | 20.5018 | 33.9974 |
| F-number | 2.76954 | 2.88596 | 2.91265 |
| View angle | 41.9656 | 28.0358 | 17.3265 |
| Image height | 10.0000 | 10.8150 | 10.8150 |
| Overall length | 77.9511 | 82.4834 | 97.5242 |
| of lens system | | | |
| d4 | 0.6000 | 5.9204 | 17.4364 |
| d11 | 11.3389 | 3.6837 | 1.0000 |
| d19 | 2.0000 | 2.6931 | 2.0676 |
| d21 | 5.3817 | 11.5557 | 18.3897 |
| Entrance pupil | 18.4872 | 25.3196 | 52.6540 |
| position | | | |
| Exit pupil | −55.7954 | −81.6433 | −131.5344 |
| position | | | |
| Front principal | 28.1132 | 40.6742 | 77.8627 |
| points position | | | |
| Back principal | 65.6415 | 62.0005 | 63.5051 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 63.21640 | 8.76700 | 0.38285 | 4.21411 |
| 2 | 5 | −12.27921 | 13.00310 | 1.39435 | 4.89610 |
| 3 | 12 | 13.45117 | 15.17310 | 8.96424 | 11.41585 |
| 4 | 20 | −23.83163 | 0.70000 | 0.54271 | 0.86000 |
| 5 | 22 | 52.35362 | 5.83060 | 4.09185 | 6.79632 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd |
|---|---|---|---|---|
| Object surface | ∞ | | | |
| 1 | 35.60130 | 1.50000 | 1.84666 | 23.8 |
| 2 | 27.06370 | 7.38170 | 1.77250 | 49.6 |
| 3 | 114.75730 | Variable | | |
| 4* | 5000.00000 | 1.00000 | 1.88202 | 37.2 |
| 5* | 10.26040 | 5.14670 | | |
| 6 | −42.37640 | 0.80000 | 1.59282 | 68.6 |
| 7 | 12.17630 | 5.46660 | 1.85000 | 32.4 |
| 8 | −35.19200 | 1.56560 | | |
| 9* | −31.92670 | 1.00000 | 1.69350 | 53.2 |
| 10* | 306.76460 | Variable | | |
| 11(Diaphragm) | ∞ | Variable | | |
| 12 | 13.09760 | 3.49910 | 1.84666 | 23.8 |
| 13 | 9.12440 | 3.61090 | 1.51845 | 70.0 |
| 14* | 550.61270 | 1.93090 | | |
| 15 | −30.50480 | 2.50330 | 1.48749 | 70.4 |
| 16 | −11.44060 | 0.80000 | 1.92286 | 20.9 |
| 17 | −15.32890 | 0.20000 | | |
| 18 | 131.77220 | 2.72210 | 1.69350 | 53.3 |
| 19 | −22.26800 | Variable | | |
| 20 | 720.65850 | 0.80000 | 1.67270 | 32.2 |
| 21 | 21.86330 | Variable | | |
| 22 | 91.44560 | 2.41440 | 1.84666 | 23.8 |
| 23 | −78.44720 | (BF) | | |
| Image surface | ∞ | | | |

TABLE 8
(Aspherical data)

Surface No. 4
K = 0.00000E+00, A4 = 3.64083E−05, A6 = −1.09762E−07,
A8 = 1.23307E−10
Surface No. 5
K = 0.00000E+00, A4 = −5.91742E−06, A6 = −5.18192E−08,
A8 = 2.31060E−09
Surface No. 9
K = 0.00000E+00, A4 = −2.39415E−04, A6 = 4.06613E−06,
A8 = −2.17154E−08
Surface No. 10
K = 0.00000E+00, A4 = −2.23523E−04, A6 = 4.02796E−06,
A8 = −2.28041E−08
Surface No. 14
K = 0.00000E+00, A4 = 1.65010E−04, A6 = 1.28378E−07,
A8 = 1.30228E−09

TABLE 9
(Various data)
Zooming ratio 2.75007

| | Wide-angle | Middle | Telephoto |
|---|---|---|---|
| | limit | position | limit |
| Focal length | 12.3619 | 20.5019 | 33.9963 |
| F-number | 2.89409 | 2.81379 | 2.91284 |
| View angle | 41.9358 | 28.0781 | 17.3340 |
| Image height | 10.0000 | 10.8150 | 10.8150 |
| Overall length | 81.5389 | 84.9915 | 100.6945 |
| of lens system | | | |
| BF | 0.00000 | 0.00000 | 0.00000 |
| d3 | 1.0000 | 7.9940 | 17.7078 |
| d10 | 10.9431 | 3.2455 | 1.5000 |
| d11 | 4.3000 | 3.0000 | 1.5000 |
| d19 | 2.0000 | 3.8270 | 2.5000 |
| d21 | 3.5945 | 7.2237 | 17.7854 |
| Entrance pupil | 19.7610 | 30.9223 | 57.4091 |
| position | | | |
| Exit pupil | −62.7077 | −69.7335 | −119.4275 |
| position | | | |
| Front principal | 29.6879 | 45.4017 | 81.7241 |
| points position | | | |
| Back principal | 69.2272 | 64.5491 | 66.6509 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 66.29441 | 8.88170 | −2.37271 | 1.77715 |
| 2 | 4 | −13.25968 | 14.97890 | 0.26457 | 4.26363 |
| 3 | 12 | 16.76783 | 15.26630 | 7.25847 | 9.11211 |
| 4 | 20 | −33.53311 | 0.80000 | 0.49346 | 0.81497 |
| 5 | 22 | 50.19881 | 2.41440 | 0.70835 | 1.80674 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd |
|---|---|---|---|---|
| Object surface | ∞ | | | |
| 1 | 47.44810 | 1.50000 | 1.84666 | 23.8 |
| 2 | 31.67890 | 0.01000 | 1.56732 | 42.8 |
| 3 | 31.67890 | 7.18960 | 1.77250 | 49.6 |
| 4 | 216.82340 | Variable | | |
| 5* | 84.41100 | 0.10000 | 1.51358 | 51.6 |
| 6 | 54.70290 | 1.00000 | 1.91082 | 35.2 |
| 7 | 10.85120 | 5.44560 | | |
| 8 | −30.21860 | 0.80000 | 1.66422 | 49.2 |
| 9 | 13.97590 | 4.43370 | 2.00069 | 25.5 |
| 10 | −53.27650 | 1.76890 | | |
| 11 | −18.46780 | 0.70000 | 1.90366 | 31.3 |
| 12 | −33.86630 | Variable | | |
| 13(Diaphragm) | ∞ | 1.50000 | | |
| 14 | 18.55120 | 3.83540 | 1.74077 | 27.8 |
| 15 | 11.55510 | 3.34470 | 1.58913 | 61.3 |
| 16* | −3000.00000 | 2.65780 | | |
| 17 | −17.95930 | 3.46840 | 1.49700 | 81.6 |
| 18 | −9.10520 | 0.70000 | 1.72342 | 38.0 |
| 19 | −13.23550 | 1.00000 | | |
| 20* | 24.87750 | 3.50410 | 1.58913 | 61.3 |
| 21* | −28.35100 | Variable | | |
| 22 | 54.07680 | 0.70000 | 1.90366 | 31.3 |
| 23 | 18.60350 | Variable | | |
| 24* | 104.82190 | 4.28520 | 1.81000 | 41.0 |
| 25* | −75.81830 | (BF) | | |
| Image surface | ∞ | | | |

TABLE 11
(Aspherical data)

Surface No. 5
K = 0.00000E+00, A4 = 3.23262E−05, A6 = −1.51447E−07,
A8 = 1.49188E−09 A10 = −1.77365E−11, A12 = 1.71943E−13,
A14 = −9.60486E−16, A16 = 2.23845E−18
Surface No. 16
K = 0.00000E+00, A4 = 4.95653E−05, A6 = 4.36297E−07,
A8 = −1.43081E−08 A10 = 1.78841E−10, A12 = 1.14002E−13,
A14 = −1.79465E−14, A16 = 0.00000E+00
Surface No. 20
K = 0.00000E+00, A4 = −3.49368E−05, A6 = 4.42209E−07,
A8 = −1.05520E−08 A10 = 1.97124E−10, A12 = −2.30284E−12,
A14 = 1.02377E−14, A16 = 0.00000E+00
Surface No. 21
K = 0.00000E+00, A4 = 5.01002E−06, A6 = 1.30223E−07,
A8 = 4.29262E−09 A10 = −1.73008E−10, A12 = 2.24723E−12,
A14 = −1.14875E−14, A16 = 0.00000E+00
Surface No. 24
K = 0.00000E+00, A4 = −2.17817E−05, A6 = 2.77427E−07,
A8 = −2.40522E−09 A10 = 1.71336E−11, A12 = −9.07006E−14,
A14 = 2.48919E−16, A16 = 0.00000E+00
Surface No. 25
K = 0.00000E+00, A4 = −1.74336E−05, A6 = −1.35455E−07,
A8 = 5.35817E−09 A10 = −5.65794E−11, A12 = 2.59090E−13,
A14 = −4.14278E−16, A16 = 0.00000E+00

TABLE 12
(Various data)
Zooming ratio 2.75034

| | Wide-angle | Middle | Telephoto |
|---|---|---|---|
| | limit | position | limit |
| Focal length | 12.3633 | 20.5015 | 34.0034 |
| F-number | 2.87984 | 2.83156 | 2.91270 |
| View angle | 41.8706 | 28.2617 | 17.4072 |
| Image height | 10.0000 | 10.8150 | 10.8150 |
| Overall length | 86.2222 | 91.5851 | 110.3829 |
| of lens system | | | |
| d4 | 0.6000 | 6.9581 | 20.8424 |
| d12 | 13.5945 | 4.4160 | 1.0000 |
| d21 | 2.0000 | 2.8153 | 2.0376 |
| d23 | 7.0092 | 14.3772 | 23.4844 |
| Entrance pupil | 19.3413 | 27.1874 | 57.1968 |
| position | | | |
| Exit pupil | −73.8353 | −117.5475 | −254.5615 |
| position | | | |
| Front principal | 29.6346 | 44.1137 | 86.6585 |
| points position | | | |
| Back principal | 73.8656 | 71.0998 | 76.4056 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 81.63256 | 8.69960 | −1.57185 | 2.36724 |
| 2 | 5 | −13.95373 | 14.24820 | 1.02850 | 4.82561 |
| 3 | 13 | 16.58980 | 20.01040 | 12.13561 | 13.95080 |
| 4 | 22 | −31.68015 | 0.70000 | 0.56586 | 0.89467 |
| 5 | 24 | 54.89887 | 4.28520 | 1.38856 | 3.28084 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd |
|---|---|---|---|---|
| Object surface | ∞ | | | |
| 1 | 58.61210 | 1.50000 | 1.84666 | 23.8 |
| 2 | 38.36070 | 10.17650 | 1.77250 | 49.6 |
| 3 | 258.92410 | Variable | | |
| 4* | 85.92700 | 0.10000 | 1.51358 | 51.6 |
| 5 | 50.15090 | 1.00000 | 1.88300 | 40.8 |
| 6 | 11.94380 | 6.45430 | | |
| 7 | −24.00780 | 0.80000 | 1.63041 | 58.7 |
| 8 | 16.59710 | 7.85820 | 2.00069 | 25.5 |
| 9 | −71.64400 | 2.32180 | | |
| 10 | −15.52280 | 0.70000 | 1.84666 | 23.8 |
| 11 | −22.19310 | Variable | | |
| 12(Diaphragm) | ∞ | 1.50000 | | |
| 13* | 20.14210 | 5.00000 | 1.73077 | 40.5 |
| 14* | 43.07590 | 1.52830 | | |
| 15 | −3549.00000 | 3.55870 | 1.83233 | 26.9 |
| 16 | 19.00960 | 4.01970 | 1.49700 | 81.6 |
| 17 | −26.42980 | 1.00000 | | |
| 18* | 26.41150 | 6.99390 | 1.58913 | 61.3 |
| 19* | −21.14710 | Variable | | |
| 20 | 64.65560 | 0.70000 | 1.72584 | 50.7 |
| 21 | 18.19200 | Variable | | |
| 22 | 80.60590 | 3.85830 | 1.81000 | 41.0 |
| 23* | −157.03860 | (BF) | | |
| Image surface | ∞ | | | |

TABLE 14
(Aspherical data)

Surface No. 4
K = 0.00000E+00, A4 = 3.07455E−05, A6 = −9.94711E−08,
A8 = 6.84142E−10 A10 = −9.86712E−12, A12 = 1.30757E−13,
A14 = −7.71155E−16, A16 = 1.68039E−18
Surface No. 13
K = 0.00000E+00, A4 = −2.76441E−05, A6 = −1.66065E−07,
A8 = 9.41781E−10 A10 = −1.30353E−11, A12 = 4.30260E−15,
A14 = 1.45715E−16, A16 = 0.00000E+00
Surface No. 14
K = 0.00000E+00, A4 = −1.20410E−05, A6 = −3.93727E−08,
A8 = −3.15440E−09 A10 = 1.27436E−11, A12 = 8.80301E−13,
A14 = −1.17203E−14, A16 = 0.00000E+00
Surface No. 18
K = 0.00000E+00, A4 = −6.54840E−05, A6 = 9.13347E−08,
A8 = −1.13091E−08 A10 = 9.46366E−11, A12 = −2.13942E−13,
A14 = −6.25779E−15, A16 = 0.00000E+00
Surface No. 19
K = 0.00000E+00, A4 = −1.15053E−05, A6 = −1.08702E−07,
A8 = −2.15758E−09 A10 = −6.18548E−11, A12 = 1.07786E−12,
A14 = −7.08738E−15, A16 = 0.00000E+00
Surface No. 23
K = 0.00000E+00, A4 = −7.52127E−08, A6 = −2.87621E−07,
A8 = 5.70372E−09 A10 = −5.90855E−11, A12 = 3.05132E−13,
A14 = −6.21957E−16, A16 = 0.00000E+00

TABLE 15
(Various data)
Zooming ratio 2.75023

| | Wide-angle | Middle | Telephoto |
|---|---|---|---|
| | limit | position | limit |
| Focal length | 12.3618 | 20.5023 | 33.9978 |
| F-number | 2.77632 | 2.82217 | 2.91265 |
| View angle | 41.9516 | 28.1578 | 17.4607 |
| Image height | 10.0000 | 10.8150 | 10.8150 |
| Overall length | 98.7863 | 106.9169 | 128.1598 |
| of lens system | | | |
| d3 | 0.6000 | 11.2728 | 27.7689 |
| d11 | 14.3588 | 4.7781 | 1.0000 |
| d19 | 2.2255 | 3.0645 | 2.0918 |
| d21 | 7.0976 | 13.2971 | 22.7947 |
| Entrance pupil | 22.7742 | 38.5972 | 77.3709 |
| position | | | |
| Exit pupil | −69.6603 | −94.2993 | −157.7777 |
| position | | | |
| Front principal | 32.9425 | 54.6426 | 104.0439 |
| points position | | | |
| Back principal | 86.4311 | 86.4283 | 94.1841 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 102.03267 | 11.67650 | −2.15799 | 3.13652 |
| 2 | 4 | −14.68979 | 19.23430 | 1.44323 | 7.07608 |
| 3 | 12 | 17.83862 | 23.60060 | 12.94928 | 16.67973 |
| 4 | 20 | −35.09898 | 0.70000 | 0.56800 | 0.85982 |
| 5 | 22 | 66.24133 | 3.85830 | 0.72832 | 2.43936 |

The following Table 16 shows the corresponding values to the individual conditions in the zoom lens systems of each of Numerical Examples.

TABLE 16
(Values corresponding to conditions)

| | Numerical Example | | | | |
|---|---|---|---|---|---|
| Condition | 1 | 2 | 3 | 4 | 5 |
| (1) T_{mainG}/T_{subG} | 6.16 | 4.79 | 14.98 | 5.28 | 3.16 |
| (2) f_{1G}/ \|f_{subG}\| | 2.40 | 2.50 | 1.59 | 3.54 | 4.84 |
| (3) L_{T}/\|f_{subG}\| | 3.18 | 3.86 | 2.42 | 4.79 | 6.08 |

The zoom lens system according to the present invention is applicable to a digital still camera, a digital video camera, a camera for a mobile terminal device such as a smart-phone, a camera for a PDA (Personal Digital Assistance), a surveillance camera in a surveillance system, a Web camera, a vehicle-mounted camera or the like. In particular, the zoom lens system according to the present invention is suitable for a photographing optical system where high image quality is required like in a digital still camera system or a digital video camera system.

Also, the zoom lens system according to the present invention is applicable to, among the interchangeable lens apparatuses according to the present invention, an interchangeable lens apparatus having motorized zoom function, i.e., activating function for the zoom lens system by a motor, with which a digital video camera system is provided.

Although the present invention has been fully described by way of example with reference to the accompanying drawings, it is to be understood that various changes and modifications will be apparent to those skilled in the art. Therefore, unless otherwise such changes and modification depart from the scope of the present invention, they should be construed as being included therein.

What is claimed is:

1. A zoom lens system having a plurality of lens units, each lens unit being composed of at least one lens element, the zoom lens system, in order from an object side to an image side, comprising:
a first lens unit having positive optical power;
a second lens unit having negative optical power;
a third lens unit having positive optical power;
a fourth lens unit having negative optical power; and
a fifth lens unit having positive optical power, wherein
the zoom lens system is provided with an image blur compensating lens unit which moves in a direction perpendicular to an optical axis in order to optically compensate image blur and which is a part of the second lens unit or a part of the third lens unit, wherein
in zooming from a wide-angle limit to a telephoto limit at the time of image taking, the first lens unit and the second lens unit individually move relative to an image surface, and wherein
the following condition (1) is satisfied:
T_{mainG}/T_{subG}>3.0 (1)
where,
T_{mainG} is an optical axial thickness of the lens unit containing the image blur compensating lens unit, and
T_{subG} is an optical axial thickness of the image blur compensating lens unit.

2. The zoom lens system as claimed in claim 1, wherein the following condition (2) is satisfied:
1.3<f_{1G}/|f_{subG}|<8.5 (2)
where,
f_{1G} is a focal length of the first lens unit, and
f_{subG} is a focal length of the image blur compensating lens unit.

3. The zoom lens system as claimed in claim 1, wherein the following condition (3) is satisfied:
1.5<L_{T}/|f_{subG}|<9.0 (3)
where,
L_{T} is an overall length of lens system at a telephoto limit, and
f_{subG} is a focal length of the image blur compensating lens unit.

4. The zoom lens system as claimed in claim 1, wherein the image blur compensating lens unit is arranged closest to the image side in the lens unit containing the image blur compensating lens unit.

5. The zoom lens system as claimed in claim 1, wherein the image blur compensating lens unit is composed of one lens element.

6. The zoom lens system as claimed in claim 1, wherein the first lens unit is composed of two or less lens elements.

7. The zoom lens system as claimed in claim 1, wherein the fifth lens unit is composed of one lens element.

8. The zoom lens system as claimed in claim 1, wherein the fifth lens unit is fixed relative to the image surface in zooming from a wide-angle limit to a telephoto limit at the time of image taking.

9. The zoom lens system as claimed in claim 1, having a focusing lens unit which moves relative to the image surface in focusing from an infinity in-focus condition to a close-object in-focus condition, wherein
the focusing lens unit is composed of one lens element.

10. The zoom lens system as claimed in claim 1, wherein an air lens located closest to the object side in the third lens unit is bi-convex.

11. An interchangeable lens apparatus comprising:
a zoom lens system as claimed in claim 1; and
a lens mount section which is connectable to a camera body including an image sensor for receiving an optical image formed by the zoom lens system and converting the optical image into an electric image signal.

12. A camera system comprising:
an interchangeable lens apparatus including a zoom lens system as claimed in claim 1; and
a camera body which is detachably connected to the interchangeable lens apparatus via a camera mount section, and includes an image sensor for receiving an optical image formed by the zoom lens system and converting the optical image into an electric image signal.
